(19) United States
(12) Patent Application Publication
(10) Pub. No.: US 2019/0255679 A1
(43) Pub. Date: Aug. 22, 2019

(54) HANDLE INTERCHANGEABILITY AND SANDPAPER RETENTION MECHANISMS FOR A SANDER

(71) Applicant: TTI (MACAO COMMERCIAL OFFSHORE) LIMITED, Macau (MO)

(72) Inventors: Clinton C. Thackery, Clemson, SC (US); Jacob F. Creasman, Anderson, SC (US)

(21) Appl. No.: 16/277,669

(22) Filed: Feb. 15, 2019

Related U.S. Application Data
(60) Provisional application No. 62/666,928, filed on May 4, 2018.
(60) Provisional application No. 62/632,233, filed on Feb. 19, 2018.

(51) Int. Cl. B24D 15/02

(52) U.S. Cl. CPC B24D 15/023; B25G 3/18

(57) ABSTRACT

A sander may include a base with first and second opposite ends and a first retention mechanism rotatably connected to the base. A longitudinal axis may be defined between the first end and the second end. A first groove may be disposed on one side of the longitudinal axis. The first retention mechanism may include a first retaining segment extending over a majority of a length of the first end. The first retention mechanism may further include a first actuating member extending from the retaining segment toward the second end. The first actuating member may be removably retained in the first groove. Actuation of the first actuating member may move the first retaining segment relative to the base for facilitating sandpaper insertion or removal.

### CROSS-REFERENCE TO RELATED APPLICATION

This application claims the benefit of U.S. Provisional Patent Application No. 62/632,233, filed Feb. 19, 2018, and U.S. Provisional Patent Application No. 62/666,928, filed May 4, 2018, the entire contents of each of which are hereby incorporated by reference.

### BACKGROUND

The present disclosure relates to sanders and more particularly to handle interchangeability and sandpaper retention mechanisms for a sander.

Sanders are tools that utilize sandpaper to smooth surfaces of a structure or workpiece via abrasion with the sandpaper. Sanders may be electrically powered or manual. Some sanders include extension poles that allow hard-to-reach surfaces such as walls and ceilings to be smoothed.

### SUMMARY

In one aspect, the disclosure provides a sander that may include a base with first and second opposite ends and a first retention mechanism rotatably connected to the base. A longitudinal axis may be defined between the first end and the second end. A first groove may be disposed on one side of the longitudinal axis. The first retention mechanism may include a first retaining segment extending over a majority of a length of the first end. The first retention mechanism may further include a first actuating member extending from the retaining segment toward the second end. The first actuating member may be removably retained in the first groove. Actuation of the first actuating member may move the first retaining segment relative to the base for facilitating sandpaper insertion or removal.

In another aspect, the disclosure provides a sander that may have a base. The base may include a first end, a second end opposite the first end, a first handle mount disposed nearer the first end than the second end, a second handle mount disposed nearer the second end than the first end, and an extension pole mount disposed between the first handle mount and the second handle mount.

In yet another aspect, the disclosure provides a sander system that may include a base, a handle, and an extension pole. The base may include a first end, a second end opposite the first end, a first handle mount disposed nearer the first end than the second end, a second handle mount disposed nearer the second end than the first end, and an extension pole mount disposed between the first handle mount and the second handle mount. The handle may include a first handle end removably connectable to the first handle mount and a second handle end removably connectable to the second handle mount. The extension pole may be removably connectable to the extension pole mount.

Other aspects of the disclosure will become apparent by consideration of the detailed description and accompanying drawings.

### BRIEF DESCRIPTION OF THE DRAWINGS

FIG. 1 is a perspective view of a sander according to one embodiment of the disclosure with sandpaper retention mechanisms in a locked position.

FIG. 2 is another perspective view of the sander of FIG. 1.

FIG. 3 is an exploded perspective view of the sander of FIG. 1.

FIG. 4 is a perspective view of the sander of FIG. 1 with the sandpaper retention mechanisms in a release position.

FIG. 5 is a perspective view of the sander of FIG. 1 including an extension pole.

FIG. 6 is a perspective view of the sander of FIG. 1 with the extension pole exploded from a base of the sander.

FIG. 7A is a perspective view of the extension pole of FIG. 5.

FIG. 7B is another perspective view of the extension pole of FIG. 5.

FIG. 8 is a perspective view of a sander according to another embodiment of the disclosure, illustrated with a handle attachment.

FIG. 9 is a perspective view of the sander of FIG. 8, illustrated with a pole attachment.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

Sandpaper is frequently replaced on a sander, for example, when the sandpaper wears out or when a different level of coarseness is desired. Some sanders may require the use of an additional tool (e.g., a screw driver, hex wrench, or the like) to release the sandpaper from the sander and to secure a new piece of sandpaper in place. This makes replacing the sandpaper cumbersome (e.g., by way of having to repeatedly locate the additional tool while on the job) and inefficient. Other sanders may use a hook and loop interface on both the sander and on the sandpaper to removably attach the sandpaper to the sander; however, this requires more expensive specialty sandpaper.

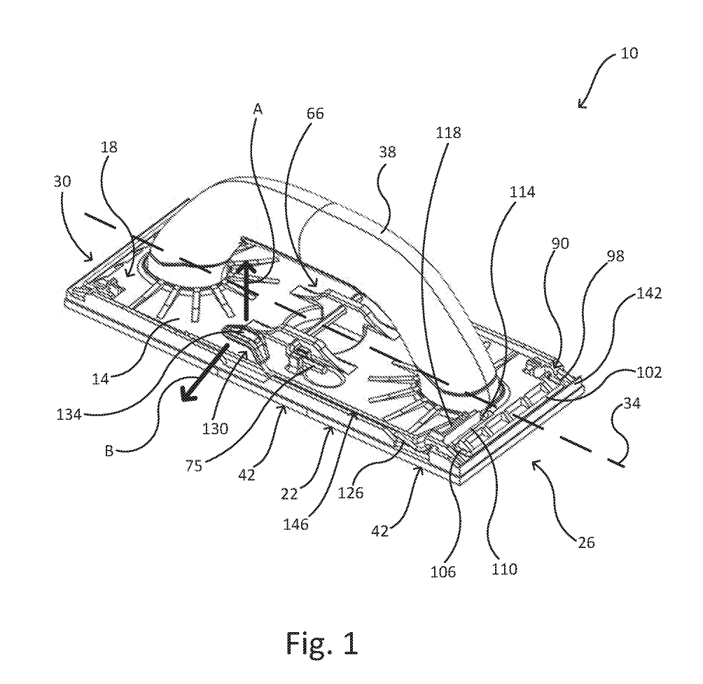

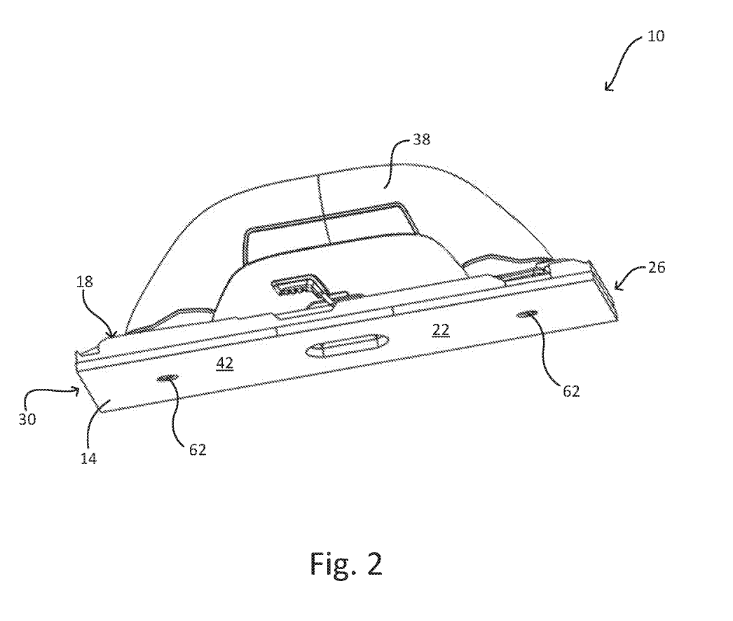

With reference to FIGS. 1 and 2, a sander 10 according to one embodiment of the disclosure may include a base 14 having a top side 18, a bottom side 22, a first end 26, and a second end 30 opposite the first end 26. A longitudinal axis 34 of the base 14 may extend centrally through the first and second ends 26, 30 (FIG. 1). A handle 38 may extend upward from the top side 18. The illustrated handle 38 is generally D-shaped; however, the handle 38 may have other shapes. The bottom side 22 of the base 14 may define a sandpaper receiving surface 42. The illustrated sander 10 is a manual sander that may be moved back and forth manually across a surface to be sanded. In other embodiments, the sander 10 may be a powered sander including, for example, a motor that causes the sandpaper receiving surface 42 to oscillate.

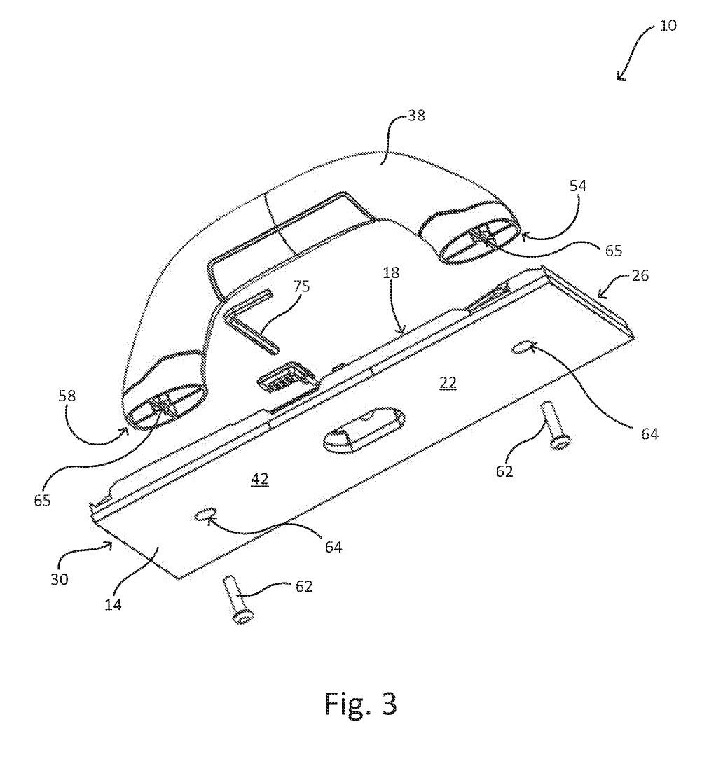

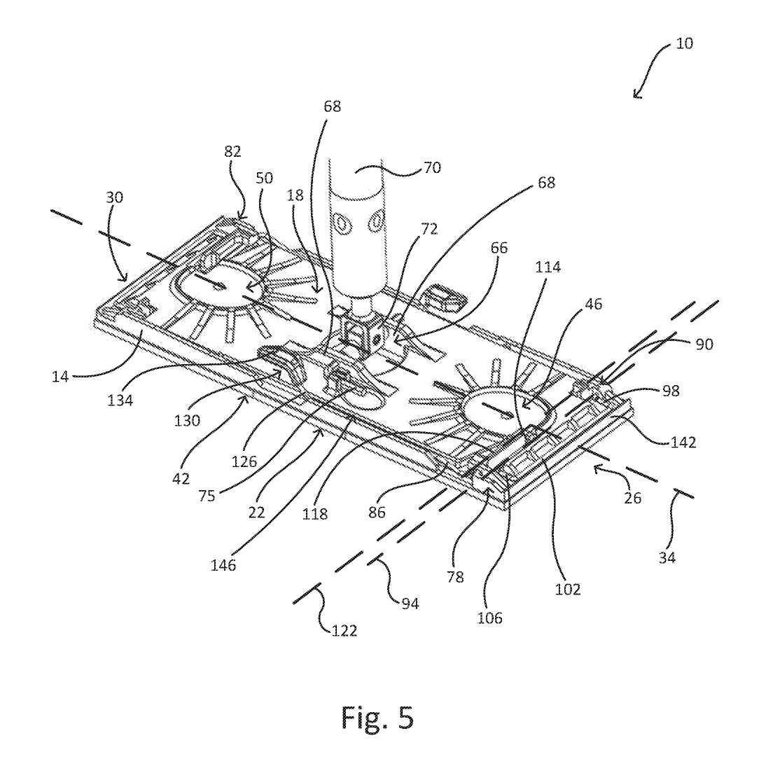

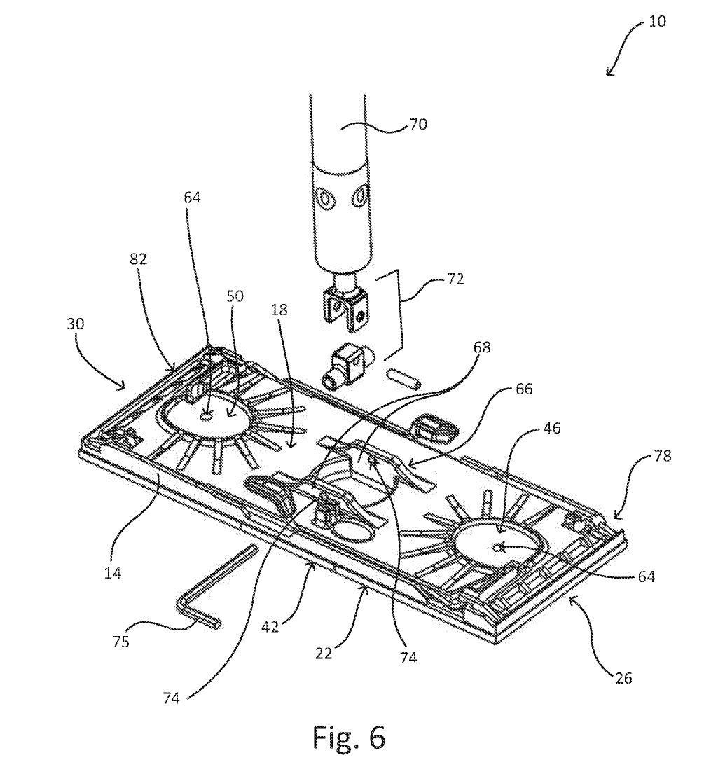

The base 14 may include first and second handle mounts 46, 50 that are aligned with the longitudinal axis 34 (FIGS. 5 and 6). A first end 54 of the handle 38 (FIG. 3) may be coupled to the first handle mount 46, and a second end 58 of the handle 38 (FIG. 3) may be coupled to the second handle mount 50. The respective first and second ends 54, 58 of the handle 38 may be coupled to the respective first and second handle mounts 46, 50 in a variety of ways, such as via fasteners 62 or a snap fit. In this way, the respective first and second ends 54, 58 may be removably coupled to the respective first and second handle mounts 46, 50 to allow the handle 38 to be removed (as shown in FIG. 3) and/or replaced. In this way, handles having different shapes, different materials, and/or the like may be interchanged respective to the base 14. In this way, a preferred handle may be selected for use during a sanding operation, which may improve the device's ergonomics and/or prevent hand cramping or muscle fatigue during the sanding operation.

As an example, a first, wooden handle (e.g., handle 38) may be replaced with a second handle made of a different material than the first handle. The second handle may include a gel or a foam material for improved comfort, and/or the like. Handles formed from other materials, such as plastic or plastic overmolded with rubber, are also contemplated. In some embodiments, the second handle may include a different size (e.g., a different diameter, a different width, and/or the like), or a different shape (e.g., a U-shape, or other non-D-shape) than the first handle. Similarly, multiple handles 38 may be secured to base 14 in some embodiments, for example, a first handle may be secured to the first handle mount 46 and a second handle may be attached to the second handle mount 50. In this way, the sander 10 may be operable using both hands (e.g., using dual ring or knob shaped handles), which may be preferred by some users.

Referring to the handle 38 shown in FIG. 3, the fasteners 62 configured to attach the handle 38 to the base 14 may include threaded bolts. The first and second handle mounts 46, 50 (FIG. 6) of the base 14 may each include a bore 64 extending therethrough by which the respective fasteners 62 may pass from the underside (e.g., bottom side 22) of the base 14 and into the handle 38. The ends 54, 58 of the handle 38 may include an internally threaded bore 65 (FIG. 3) configured to receive an end of the corresponding fastener 62 that couples the handle 38 to the base 14. Other types of fasteners may be used to couple the handle 38 to the base 14, and are contemplated. For example, the fasteners may be nuts that engage externally threaded posts extending from the ends 54, 58 of the first handle 38.

Referring to FIG. 5, the sander 10 may further include an extension pole mount 66 generally aligned with the longitudinal axis 34 and centered between the first and second handle mounts 46, 50, in some embodiments. The extension pole mount 66 includes a pair of projections 68 (e.g., lobes) that extend upward from the base 14. In the illustrated embodiment, an extension pole 70 having a universal joint 72 disposed at an end of the pole may be coupled to the extension pole mount 66 between the projections 68 when the handle 38 is removed. In this way, the sander 10 may be employed as a hand sander and as a pole sander for use on different surfaces (e.g., furniture, floors, ceilings, and/or the like) to be sanded.

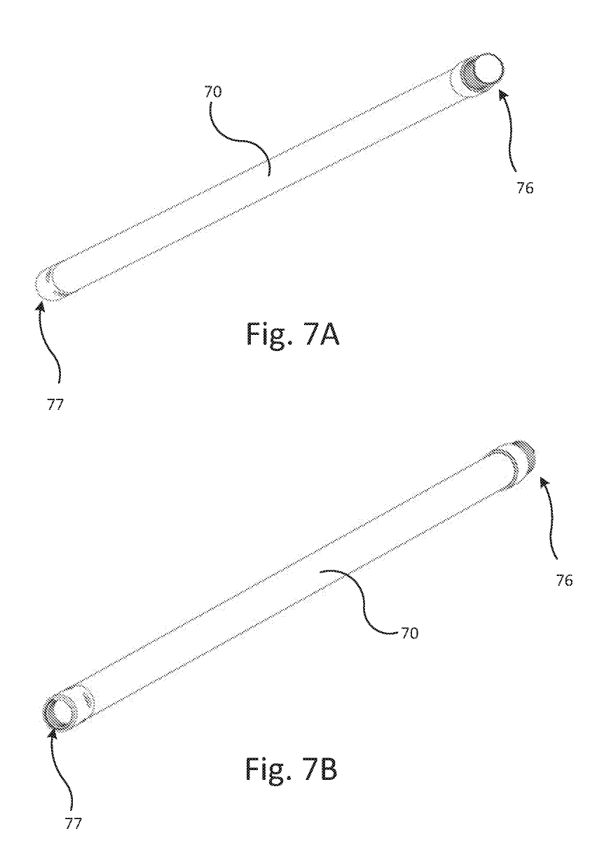

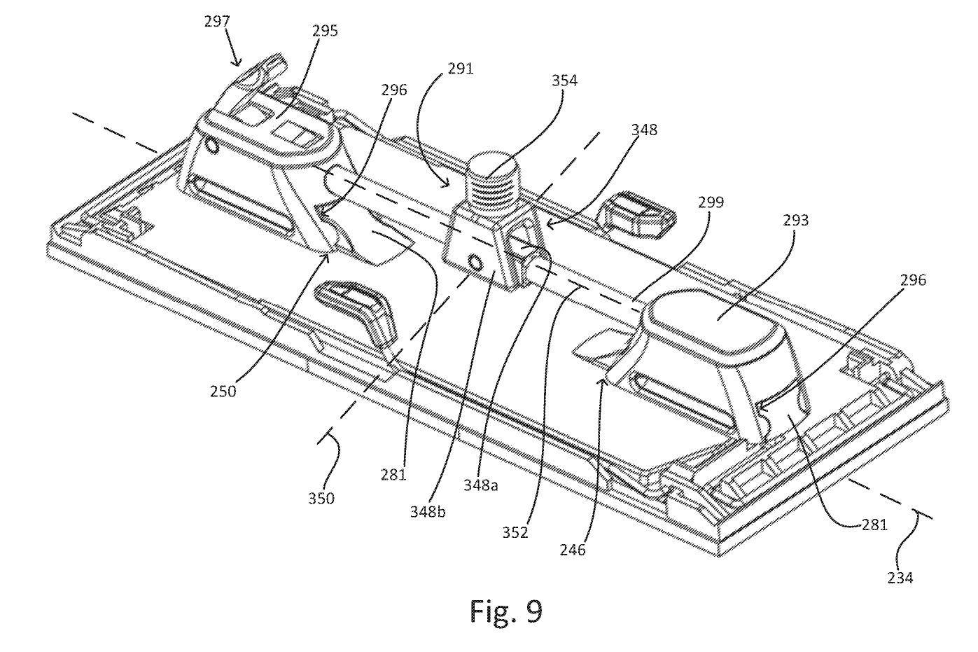

As shown in FIG. 6, the projections 68 may include a respective bore 74 defined therein. In the illustrated embodiment, a coupling member 75 (e.g., a hex key, a driver, a pin, a bar, and/or the like) may connect the universal joint 72 of the extension pole 70 to the extension pole mount 66. Particularly, the coupling member 75 may be passed into and extend through the bores 74 defined in each of the projections 68 as well as through a portion of the universal joint 72. The coupling member 75 may extend along an axis that is transverse to the longitudinal axis 34 of the base 14. In this way, the extension pole 70 and sander 10 assembly may be configured for use on ceilings and high walls. The extension pole 70, illustrated in FIGS. 7A and 7B, may include a threaded end 76 that is connectable to the universal joint 72 and, therefore, to the extension pole mount 66. The illustrated extension pole 70 may also include a threaded recess 77 opposite the threaded end 76. As such, multiple extension poles 70 may be connected to each other to offer length selection of the extension pole 70. Similarly, the dual-ended pole 70 may be configured for use with joints (e.g., universal joint 72, non-universal joints, etc.) including female ends (e.g., shown in FIG. 6) or joints including male ends (see, e.g., gimbal 348, FIG. 9). For example, the extension pole 70 may be connected to the universal joint 72 and/or to other extension poles 70 in other ways (e.g., bayonet connections, set screws, friction fit, etc.).

With reference to FIG. 3, the coupling member 75 may be sized to be engageable with the fasteners 62, which may include hex screws (or hex bolts) in some embodiments. As such, the coupling member 75 may be stored in the extension pole mount 66 even when the extension pole 70 is not attached to the sander 10. For example, the coupling member 75 may be retained by the projections 68 of the extension pole mount 66 (see e.g., FIG. 1) when not in use, so that the coupling member 75 may be quickly and easily accessed for improved substitution of the handle 38 for another type of handle and/or for the extension pole 70. In this way, tool beyond what is provided with the sander 10 is not required to convert the sander 10 from having the extension pole 70 to having the handle 38, and vice versa. The coupling member 75 may be simply removed from the extension pole mount 66 to remove the extension pole 70. Similarly, the handle 38 may be positioned by placing the first end second ends 54, 58 of the first handle against the first and second handle mounts 46, 50 of the base 14. Once the first handle 38 is properly positioned, the coupling member 75 may be used to secure (e.g., via screwing, torqueing, tightening, and/or the like) the fasteners 62 to the base 14 thereby securing the handle 38 to the base 14. The coupling member 75 may then be returned to the extension pole mount 66 for improved storage of the coupling member 75 in the sander 10. This process may be repeated to remove the first handle 38 and connect the base 14 to another handle, the extension pole 70, and/or the like.

With reference to FIGS. 1, 5, and 6, the sander 10 may include a first sandpaper retention and release mechanism 78 (or simply, “retention mechanism”) proximate the first end 26 and a second retention mechanism 82 proximate the second end 30. In the illustrated embodiment, the first and second retention mechanisms 78, 82 are substantially identical. Accordingly, only the first retention mechanism 78 is described in detail herein.

Referring to FIGS. 1 and 5, the first retention mechanism 78 may include a resilient wire 86 with a first end 90 pivotally coupled to base 14 to define a first pivot axis 94. The wire 86 may be at least partially formed in a general U-shape that conforms to a general U-shape of the base 14. For example, the wire 86 may include a first segment 98 extending from the first end 90 in a direction generally perpendicular to the first pivot axis 94, and a second segment 102 (e.g., a trap segment, a retaining segment, and/or the like) extending from the first segment 98 in a direction generally parallel to the first pivot axis 94. The wire 86 may further include a third segment 106 extending from the second segment 102 in a direction generally perpendicular to the first pivot axis 94, a fourth segment 110 (FIG. 1) extending from the third segment 106 in a direction generally parallel to the first pivot axis 94, and a fifth segment 114 extending from the fourth segment 110 in a direction generally perpendicular to the first pivot axis 94. A sixth segment 118 of the wire 86 may extend from the fifth segment 114, and the sixth segment 118 may be pivotally coupled to the base 14 to define a second pivot axis 122 that may be parallel to the first pivot axis 94. The second pivot axis 122 may further be spaced apart from the first pivot axis 94. A seventh segment, configured as an actuating member 126 (e.g., a lever, and/or the like), may extend from the sixth segment 118 and terminate at a second end 130 of the wire 86, which may be covered by a grip 134. The arrangement and number of segments of the wire 86 may vary.

In some embodiments, the wire 86 may be continuous from the first end 90 to the second end 130, and the transitions between the various segments 98, 102, 106, 110, 114, 118, 126 may be defined by curves or bends in the wire 86. The second segment 102 of the wire 86, which may be configured to engage and/or releasably retain a sheet of sandpaper against the base 14 during use of the sander 10, may extend adjacent a ridge 142 formed at the first end 26 of the base 14. The base 14 may also include a groove 146 that is formed on, over, and/or in the top side 18 of the base 14. The groove 146 is configured to receive and/or retain the actuating member 126.

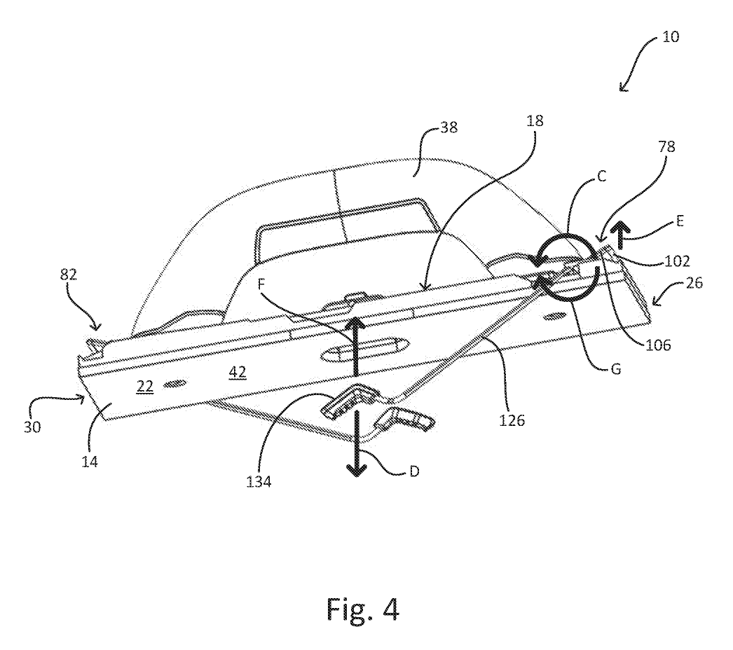

In operation, the first and second retention mechanisms 78, 82 may be operable independently to retain or release opposite ends of a piece of sandpaper. Particularly, each retention mechanism 78, 82 may be movable between a locked position (FIG. 2), an unlocked position, and a release position (FIG. 4). When in the locked position, the retention mechanisms 78, 82 may retain a piece of sandpaper flush against the bottom side 22 of the base 14. The retention mechanisms 78, 82 may be unlocked via releasing the respective actuating member 126 from the groove 146 as described herein, so that in the release position an end of the sandpaper may be loosened or released from the base 14. In this way, the piece of sandpaper may be removed and/or replaced. To unlock the first retention mechanism 78, the actuating member 126 (e.g., via the grip 134) may be lifted up in the direction of arrow A (FIG. 1). Because the second segment 102 may be engaged with the base 14 at this point, the wire 86, or a portion thereof, may elastically deform to allow the actuating member 126 to be lifted out of the groove 146.

Once removed and clear of the groove 146, the actuating member 126 may be moved (e.g., forced, pushed, and/or the like) outward from the base 14 to the unlocked position, in the direction of arrow B. In some embodiments, the actuating member 126 may be biased outward so as to automatically move in the direction of arrow B upon clearing the groove 146. The retention mechanism 78 may be pivoted in the direction of arrow C, by pushing down on the actuating member 126 in the direction of arrow D (FIG. 4). This may cause the second segment 102 to lift up in the direction of arrow E. In this way, an end of a new sheet of sandpaper may then be positioned under the second segment 102, or an end of an old sheet of sandpaper may be removed from under the second segment 102.

To lock the first retention mechanism 78 and retain the sandpaper, the actuating member 126 may be moved (e.g., via lifting, sliding, and/or the like) in the direction of arrow F (FIG. 4), causing the first retention mechanism 78 to pivot in the direction of arrow G (FIG. 5). As the first retention mechanism 78 pivots, the sandpaper may be pressed downward by the second segment 102 and into engagement with the ridge 142. The second segment 102 may bear against the base 14 as the actuating member 126 continues to move (e.g., lift) toward the locked position, and the wire 86 may elastically deform to permit continued movement of the actuating member 126. The wire 86 may remain elastically deformed (e.g., in torsion) when the lever 126 is placed in the groove 146 in the locked position (FIG. 5). This may maintain a continued downward force or pressure on the sandpaper to hold the sandpaper in place. The sandpaper may be wrapped over the sandpaper receiving surface 42 of the base 14, and the opposite end of the sandpaper secured via the second retention mechanism 82 in the same manner described above.

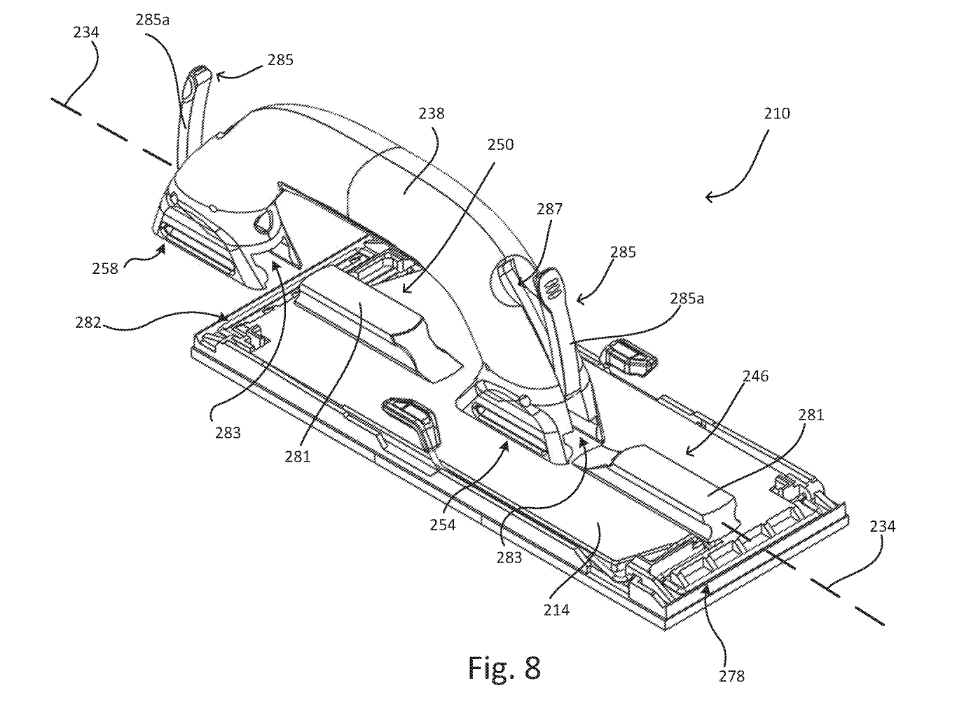

FIGS. 8 and 9 illustrate a sander 210 according to another embodiment. The sander 210 is similar to the sander 10 described above with reference to FIGS. 1-6. The following description, therefore, focuses primarily on aspects of the sander 210 that differ from the sander 10. In addition, features and elements of the sander 210 corresponding with features and elements of the sander 10 are given like reference numerals, plus “200.” It should also be understood that any of the features and elements of the sander 10 described above may be equally applicable to and incorporated in the sander 210, and vice versa.

With reference to FIG. 8, the sander 210 includes a base 214, a first handle 238, and first and second sandpaper retention and release mechanisms 278, 282. First and second handle mounts 246, 250 of the sander 210 may each include a raised mounting portion, which may be in the form of a dovetail rail 281. The dovetail rail 281 may extend along the longitudinal axis 234 of the base 214. Each of the ends 254, 258 of the first handle 238 may include a corresponding dovetail slot 283 that is receivable onto a respective dovetail rail 281. In other embodiments, the rails 281 and the slots 283 may have other cooperating geometries, such as a T-slot and T-rail interface, and the like.

The first handle 238 may further include a cam lock 285 at each of the ends 254, 258. Each cam lock 285 may include a lever 285a and a cam lobe (not shown) at an end of the lever 285a. Each of the cam locks 285 may pivot between a locked position and an unlocked position (illustrated in FIG. 8). In the locked position, each lever 285a may be pressed into a respective slot 287 defined in the first handle 238, and each cam lobe may engage and bear against the top side of the respective dovetail rail 281. As such, the upper surfaces of each dovetail slot 283 may be pressed upward into engagement with the underside surfaces of each corresponding dovetail rail 281, thereby creating a friction lock securing the first handle 238 in place on the base 214. In the unlocked position, each lever 285a may be pivoted outward from the first handle 238, as illustrated in FIG. 8, thereby withdrawing the respective cam lobe away from the respective dovetail rail 281. Once there is sufficient clearance between each dovetail rail 281 and the respective dovetail slot 283, the first handle 238 may slide freely along the dovetail rails 281. Thus, the first handle 238 may be removed or repositioned relative to the base 214 when the cam locks 285 are in the unlocked position.

Referring to FIG. 9, the sander 210 may be converted to a pole attachment configuration by removing the first handle 238 from the first and second handle mounts 246, 250 and attaching a pole adapter 291 to the first and second handle mounts. The illustrated pole adapter 291 may include first and second attachment portions 293, 295. Each attachment portion 293, 295 may be provided with a dovetail slot 296 configured to receive a respective dovetail rail 281 of the base 214 in the same manner as the dovetail slots 283 of the first handle 238. The pole adapter 291 may also include a cam lock 297 on at least one of the attachment portions 293, 295. The illustrated embodiment includes the pole adapter 291 having a cam lock 297 on the second attachment portion 295. The cam lock 297 may be similar to the cam locks 285 described above.

With continued reference to FIG. 9, a rod 299 may extend between the attachment portions 293, 295, and defines a first portion 348a of a gimbal 348. A second portion 348b of the gimbal 348 is pivotally coupled to the rod 299 about a first axis 350, and the rod 299 may be pivotal relative to the attachment portions 293, 295 about a second axis 352 transverse to the first axis. When the pole adapter 291 is coupled to the base 214, the second axis 352 may be oriented parallel to the longitudinal axis 234 of the base 214. The second portion 348b of the gimbal 348 may include an attachment interface 354 for attachment to an extension pole 70 (FIGS. 7A-7B). The attachment interface 354 may include threads, a quick-release connector, or any other means for attaching the gimbal 348 and the extension pole 70.

In operation, to change the sander 210 from the pole attachment configuration (FIG. 9) to a D-handle attachment configuration (FIG. 8), the cam lock 297 may be unlocked and the pole adapter 291 may be slid off of the first and second mounts 246, 250. The dovetail slots 283 may then be aligned on the first handle 238 with the dovetail rails 281, and the first handle may slide on the rails. Once the dovetail rails 281 are fully received within the dovetail slots 283, at which point the handle 238 may be centered over the base 214, the levers 285a may then be pivoted on the cam locks 285 to the locked position. A friction lock may then be created between the dovetail slots 283 and the dovetail rails 281 to secure the first handle 238 in position. The first handle 238 may then be grasped to move the sander 210 back and forth across a workpiece to be sanded. The above process may be repeated in reverse in order to remove the first handle 238 and install the pole adapter 291.

Thus, the disclosure provides a sander 10, 210 with interchangeable handles 38, 70, 238 and tool-free sandpaper retention mechanisms 78, 82, 278, 282. Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A sander comprising:
a base including:
a first end;
a second end opposite the first end;
a longitudinal axis defined between the first end and the second end; and
a first groove disposed on one side of the longitudinal axis;
a first retention mechanism rotatably connected to the base, the first retention mechanism including:
a first retaining segment extending over a majority of a length of the first end; and
a first actuating member extending from the retaining segment toward the second end, the first actuating member being removably retained in the first groove; and
wherein actuation of the first actuating member moves the first retaining segment relative to the base for facilitating sandpaper insertion or removal.

2. The sander of claim 1, wherein the first retention mechanism is rotatably connected to the base about a first pivot axis.

3. The sander of claim 2, wherein:
the first retaining segment pivots relative to the base about the first pivot axis;
the first actuating member pivots relative to the base about a second pivot axis; and
the second pivot axis is spaced apart from the first pivot axis.

4. The sander of claim 3, wherein the first pivot axis and the second pivot axis are parallel to each other.

5. The sander of claim 1, wherein a portion of the first retention mechanism is generally U-shaped.

6. The sander of claim 1, wherein the first retention mechanism comprises a wire.

7. The sander of claim 1, further comprising:
a first handle mount disposed proximate to the first end;
a second handle mount disposed proximate to the second end; and
an extension pole mount disposed between the first handle mount and the second handle mount.

8. The sander of claim 7, wherein:
a first handle is releasably connectable to the first and second handle mounts, and an extension pole is releasably connected to the extension pole mount.

9. The sander of claim 1, wherein:
the base includes a sandpaper receiving surface extending between the first end and the second end, the sandpaper receiving surface being configured to receive the sandpaper;
the first actuating member and the first retaining segment are movable together relative to the base to define a locked position and a release position of the first retention mechanism;
the first retaining segment is configured to engage the sandpaper when in the locked position for retaining the sandpaper against the sandpaper receiving surface; and
the first retaining segment is configured to release the sandpaper when in the release position for facilitating removal of the sandpaper from the sandpaper receiving surface.

10. The sander of claim 1, wherein the first actuating member projects beyond a longitudinal edge of the base when in the release position.

11. The sander of claim 1, wherein the first actuating member is biased away from the longitudinal axis.

12. The sander of claim 1, wherein:
the base includes a second groove disposed on an opposite side of the longitudinal axis from the first groove; and
the sander further comprises:
a second retention mechanism rotatably connected to the base, the second retention mechanism including:
a second retaining segment extending over a majority of a length of the second end; and
a second actuating member extending from the second retaining segment toward the first end, the second actuating member being removably retained in the second groove.

13. A sander comprising:
a base including:
a first end;
a second end opposite the first end;
a first handle mount disposed nearer the first end than the second end;
a second handle mount disposed nearer the second end than the first end; and
an extension pole mount disposed between the first handle mount and the second handle mount.

14. The sander of claim 13, wherein the base further includes:
a sandpaper receiving surface;
a mount side opposite the sandpaper receiving surface;
a first mount fastener opening defined in the base and extending through the sandpaper receiving surface and the mount side; and
a second mount fastener opening defined in the base and extending through the sandpaper receiving surface and the mount side.

15. The sander of claim 13, further comprising:
a handle including a first handle end and a second handle end,
the first handle end being removably connected to the first handle mount, and
the second handle end being removably connected to the second handle mount.

16. The sander of claim 15, further comprising:
a universal joint; and
a coupling member extending through the universal joint and the extension pole mount to couple the universal joint to the extension pole mount,
wherein a first mount fastener removably connects the first handle end to the first handle mount,
wherein a second mount fastener removably connects the second handle end to the second handle mount, and
wherein the coupling member is configured to cooperate with the first mount fastener and the second mount fastener to facilitate tightening and loosening of the first mount fastener and the second mount fastener.

17. The sander of claim 16, further comprising an extension pole pivotally and removably connected to the extension pole mount.

18. The sander of claim 16, wherein the coupling member comprises a hex key.

19. A sander system comprising:
a base including:
a first end;
a second end opposite the first end;
a first handle mount disposed nearer the first end than the second end;
a second handle mount disposed nearer the second end than the first end; and
an extension pole mount disposed between the first handle mount and the second handle mount;
a handle including a first handle end removably connectable to the first handle mount, and a second handle end removably connectable to the second handle mount; and
an extension pole removably connectable to the extension pole mount.

20. The sander system of claim 19, wherein
the handle is a first handle; and
the sander system further includes a second handle removably connectable to the first handle mount and the second handle mount.
